(19) United States
(12) Patent Application Publication
(10) Pub. No.: US 2013/0346501 A1
(43) Pub. Date: Dec. 26, 2013

(54) System and Method for Calculating Global Reputation

(71) Applicant: SPIGIT, INC., Pleasanton, CA (US)

(72) Inventors: Manas S. Hardas, Fremont, CA (US); Hutch Carpenter, San Francisco, CA (US); Madhukar Govindaraju, Cupertino, CA (US); Lisa S. Purvis, Pleasanton, CA (US)

(21) Appl. No.: 13/918,180

(22) Filed: Jun. 14, 2013

Related U.S. Application Data
(60) Provisional application No. 61/664,727, filed on Jun. 26, 2012.

(51) Int. Cl. H04L 29/08

(52) U.S. Cl. CPC H04L 67/22
USPC 709/204

(57) ABSTRACT

As social networks become more powerful and sophisticated, each member of a social network may belong to different communities. The computing reputation for users in a single community is not adequate anymore. As a result, a method of calculating global reputation for each member is desirable. Various considerations are described to address challenges related to global reputation for a user who participates in activities among multiple communities. Considerations on accessibility of a community, quality vs. quantity of submissions, posting ideas vs. comments, weighting of each community, and volatility of the reputation value are discussed in the present invention. Finally, a formula for calculating a global reputation value of the user is proposed by combining all the considerations. A system that implements the global reputation computation is described.

### RELATED APPLICATIONS

The present application claims priority under 35 U.S.C. §119 from U.S. Provisional Application No. 61/664,727, entitled “System and Method for Calculating Global Reputation,” filed on Jun. 26, 2012, the subject matter of which is incorporated herein by reference.

### TECHNICAL FIELD

The present invention relates generally to the calculation of global reputation in a social network having multiple communities.

### BACKGROUND

Social recognition is an important motivator in modern society. Having your actions result in immediate feedback fosters engagement. Finding and filtering experts progresses the innovation dialog. In order to establish a qualitative way of defining reputation, various computing methods are proposed to calculate reputation rank in interactive systems, such as idea submission and evaluation systems, among multiple users. As social networks become more powerful and sophisticated, each member of a social network may belong to different communities. The computing reputation for users in a single community is no longer adequate anymore. As a result, a method of calculating global reputation for a user participating in multiple communities is desirable.

### SUMMARY

A community in the context of present invention refers to a group of users who conduct activities related to certain subject domain. For an example, users having the same interest in literature can form an online group which is used to post works, provide feedbacks and conduct discussions. In another example, professional and amateur photographers exchange photos by posting and commenting within an online community group. In general, the activities users perform can be categorized into posting, commenting and voting. By posting, a user can submit creative ideas or original works. A user can also provide feedbacks by making comments on submitted ideas or related events. For either a submitted idea or comment, a user can vote for it (up) or against it (down).

A user reputation in a community is determined by his contribution. Higher reputation comes from greater contribution. Contribution can be measured by both participation as well as quality of the activities. Moreover, the quality of the activities can be calculated by how many up or down votes a user receives for his/her submitted ideas and comments. However, when a user participates in multiple communities, the functionality of determine the overall reputation quantitatively is lacked in existing systems and literatures.

In the preset invention, the concept of global reputation for a user involved multiple communities is introduced. Various considerations are described to address challenges related to global reputation for the user who participates in activities among multiple communities. Considerations on accessibility of a community, quality vs. quantity of submissions, posting ideas vs. comments, weighting of each community, and volatility of the reputation value are discussed in the present invention. Furthermore, a computation method to calculating the global reputation and a system which implements the method are proposed.

In one embodiment, a server computer generates a first activity stats of a user associated with a first community, wherein the first activity stats indicates a rating on ideas submitted to the first community by the user and a rating on comments submitted to the first community by the user. The server computer also generates a second activity stats of the user associated with a second community, wherein the second activity stats indicates a rating on ideas submitted to the second community by the user and a rating on comments submitted to the second community by the user. Next, the server computer calculates a first reputation value for the user in the first community and a second reputation value for the user in the second community. Finally, the server computer calculates a global reputation value for the user based on the first reputation value and the second reputation value. In one example, the rating on ideas submitted to the first community by the user is based on an average number of up votes received per idea for the user divided by an average number of up votes received per idea for all users of the first community.

### BRIEF DESCRIPTION OF DRAWS

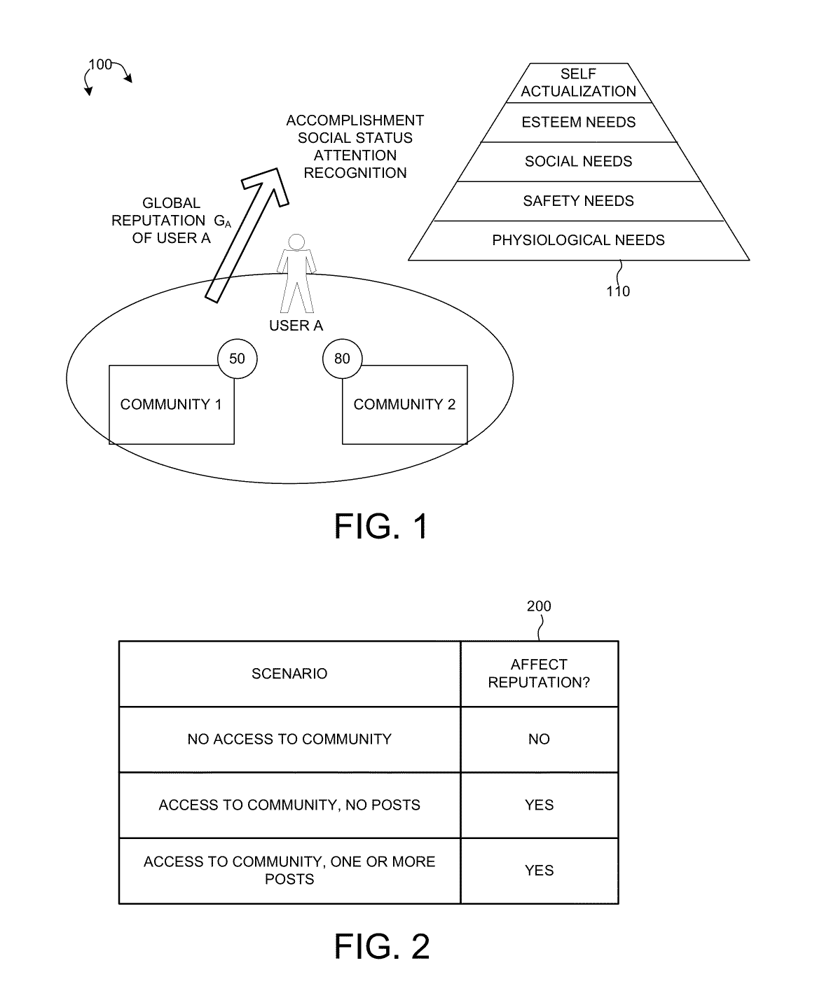

FIG. 1 illustrates a method of determining global reputation of a user in a social network with multiple communities in accordance with one novel aspect.

FIG. 2 illustrates a first consideration for determining user's reputation based on user's level of participation.

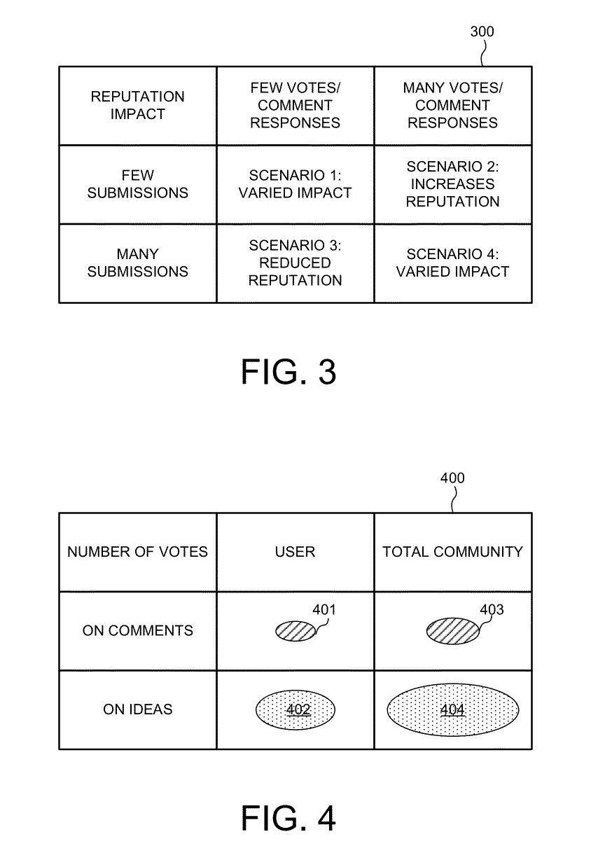

FIG. 3 illustrates a second consideration for determining user's reputation based on quantity vs. quality of participation.

FIG. 4 illustrates a third consideration for determining user's reputation based on content types.

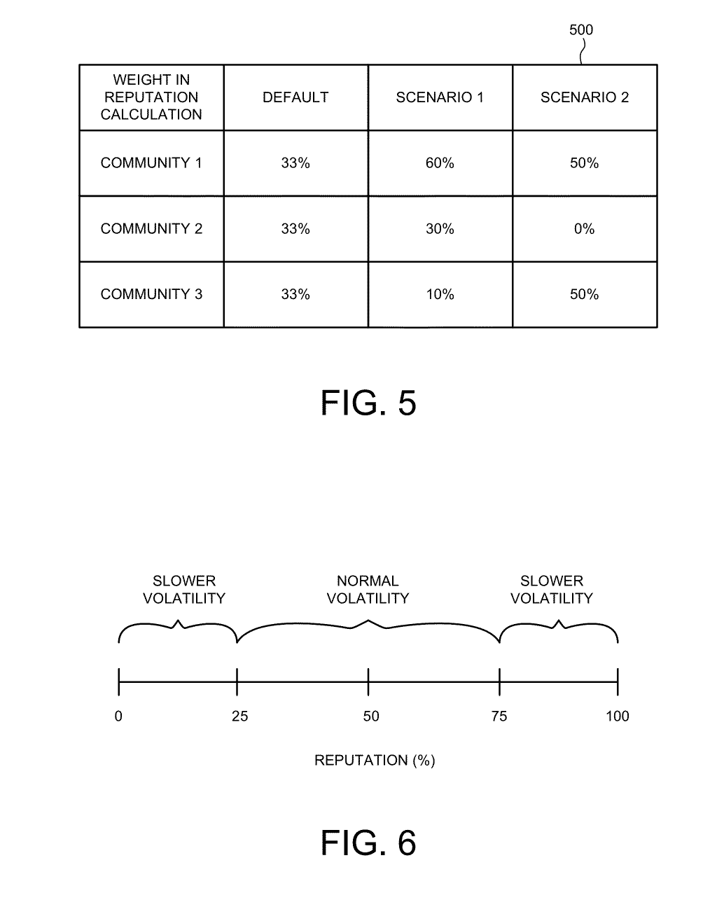

FIG. 5 illustrates a fourth consideration for determining user's global reputation based on weighting coefficients of different communities.

FIG. 6 illustrates a fifth consideration for determining user's global reputation based on slower volatility at the extremes.

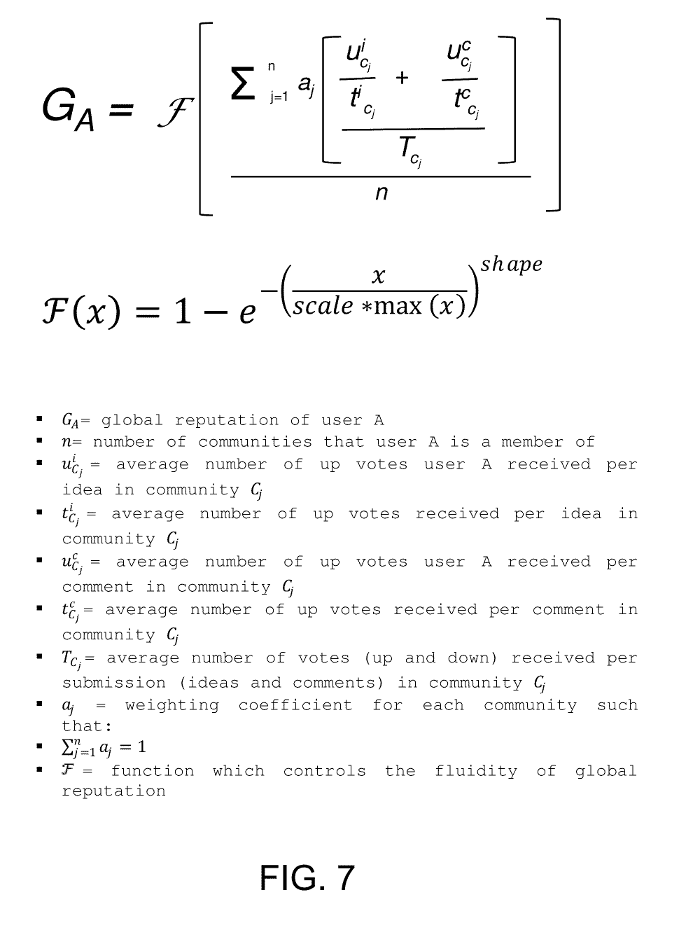

FIG. 7 illustrates a formula of calculating a global reputation GA for user A from a plurality of community statistics.

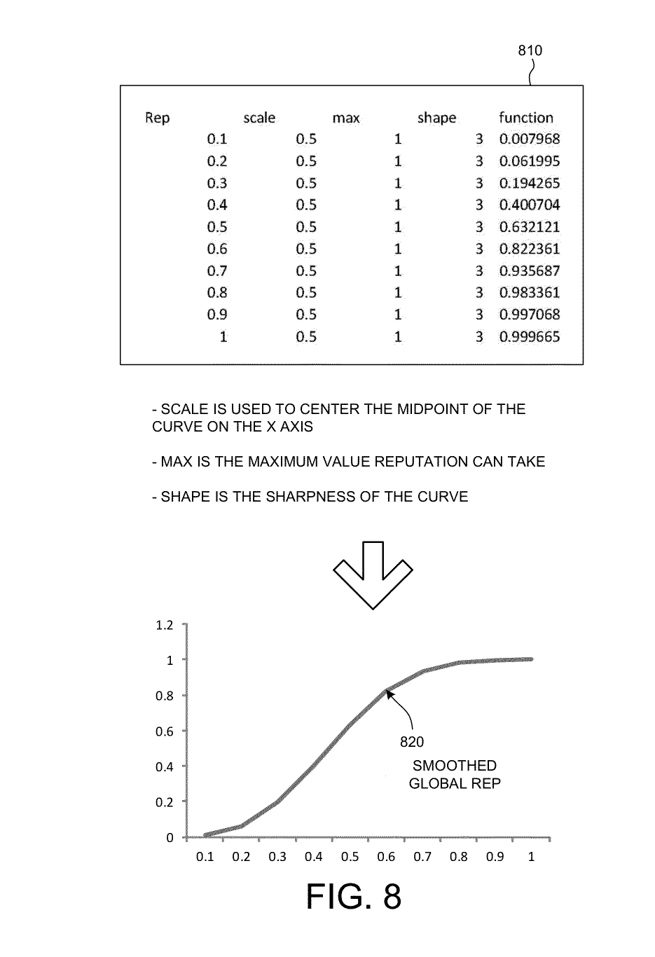

FIG. 8 illustrates an example of a curve smoothing function that can be applied for calculating global reputation values.

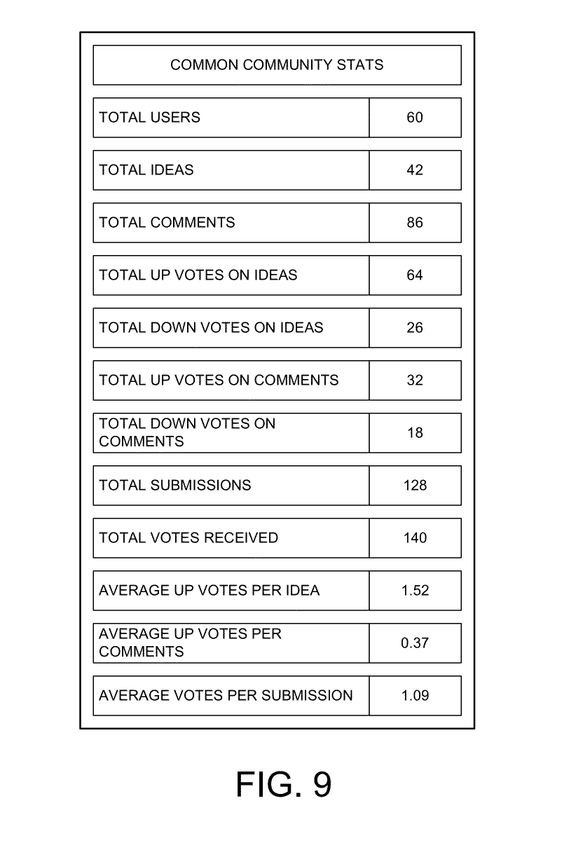

FIGS. 9-13 illustrates one example of calculating a global reputation value of a user across multiple communities.

FIG. 9 illustrates the common community statistics for all users and all submissions/votes.

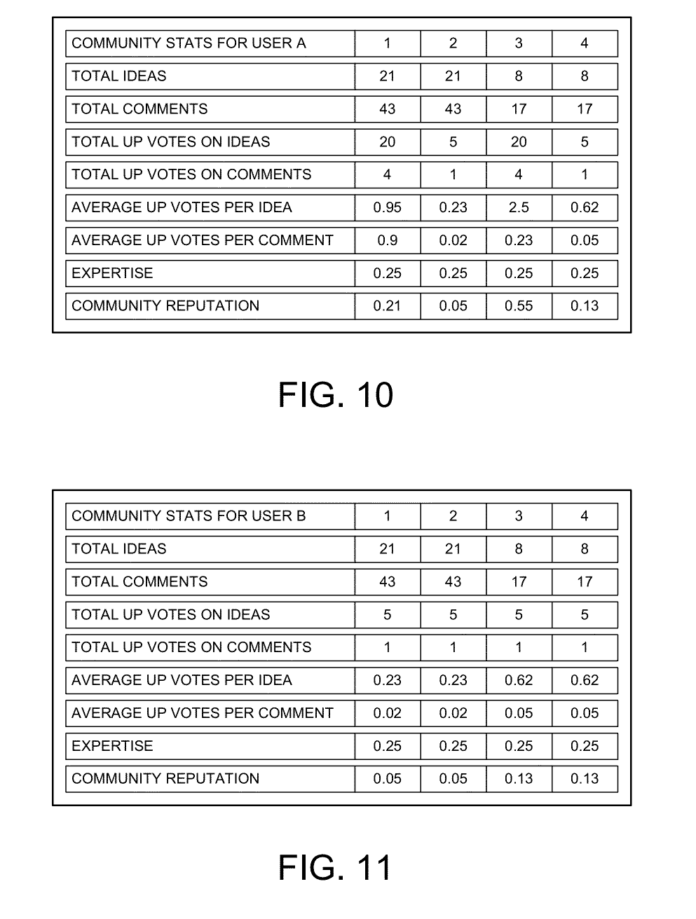

FIG. 10 illustrates community statistics for user A and the corresponding community reputation values for each community.

FIG. 11 illustrates community statistics for user B and the corresponding community reputation values for each community.

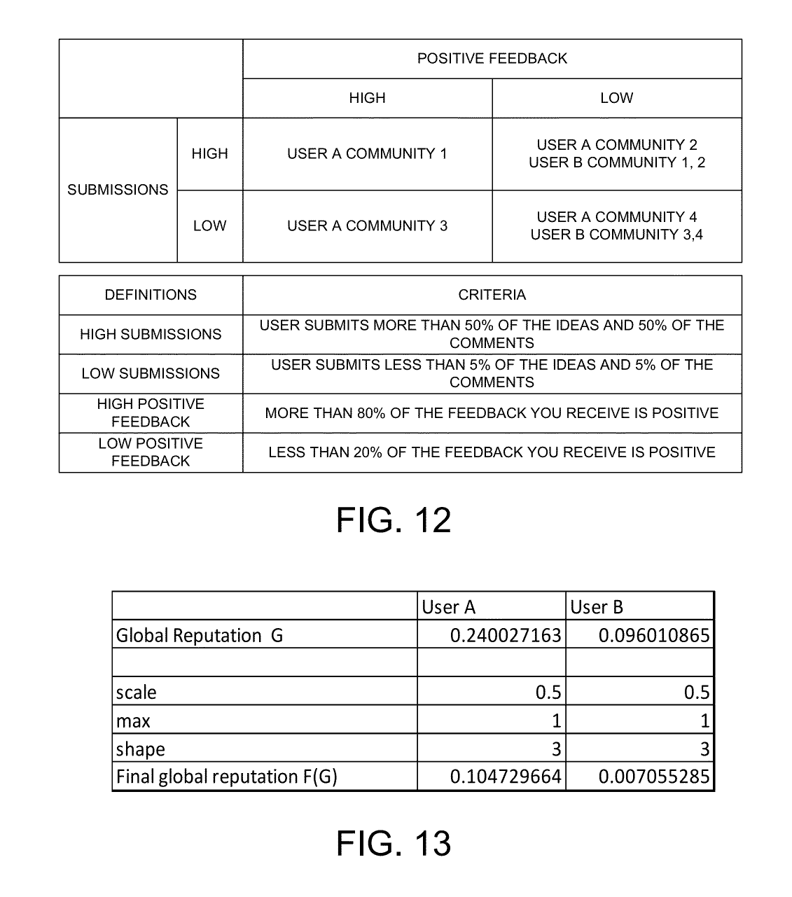

FIG. 12 illustrates an example of high/low positive feedback (F) and high/low submission (S).

FIG. 13 illustrates the global reputation values of user A and user B, and the final global reputation values of user A and user B after applying a curve smoothing function to regulate the fluidity of reputation values.

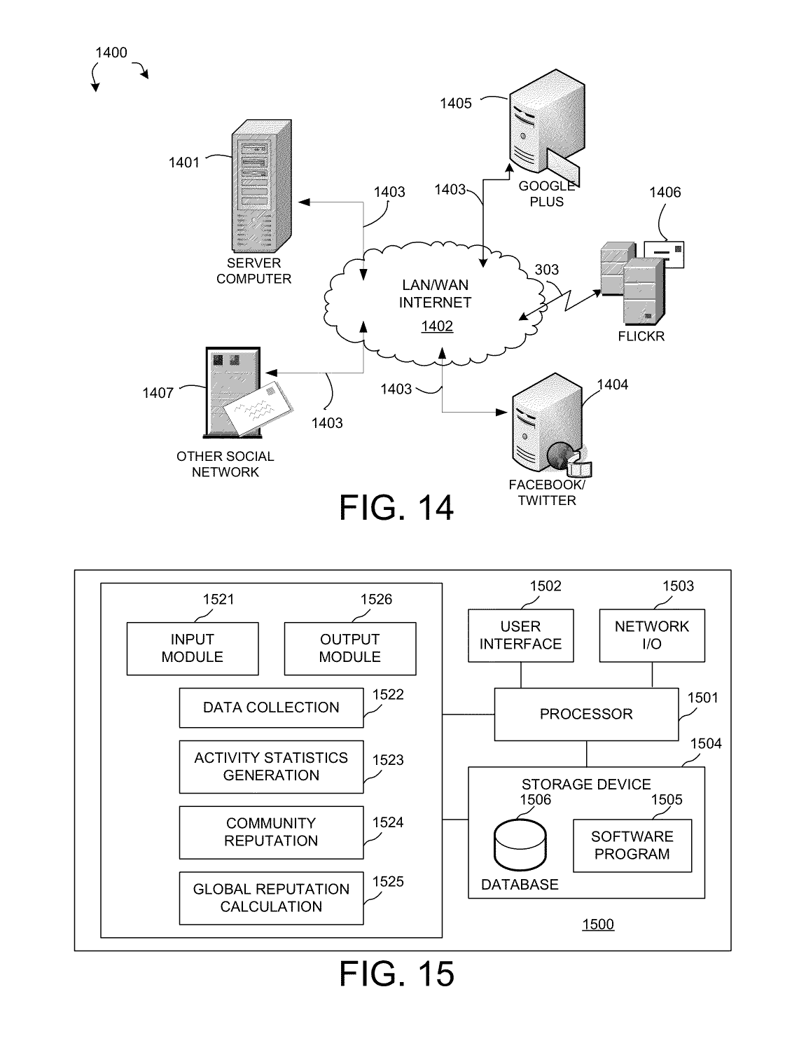

FIG. 14 is a high level diagram illustrating a system that computes global reputation in accordance with one novel aspect.

FIG. 15 is a simplified block diagram of a server computer that computes global reputation.

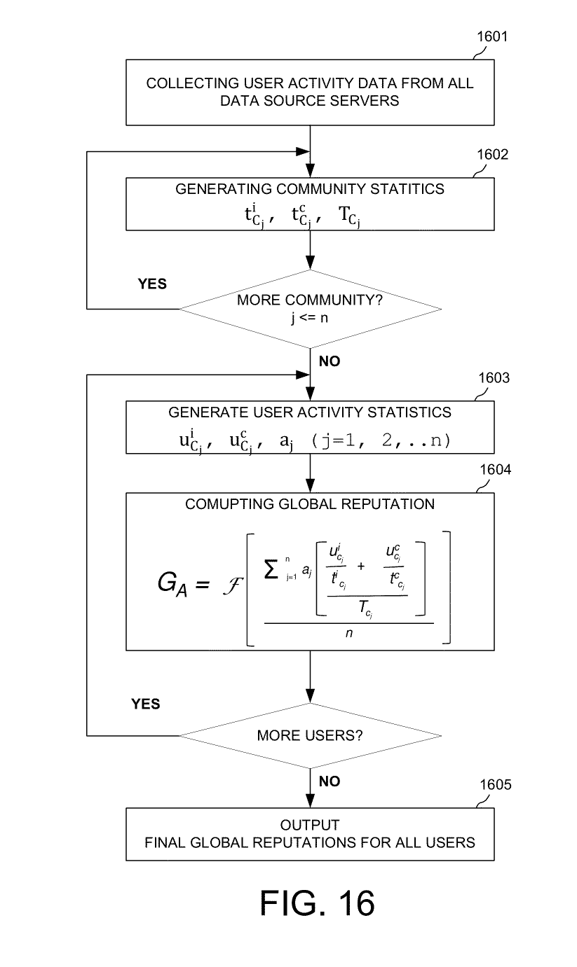

FIG. 16 is a flow chart that calculates global reputation of a user in a social network with multiple communities.

### DETAIL DESCRIPTION OF DRAWS

Reference will now be made in detail to some embodiments of the invention, examples of which are illustrated in the accompanying drawings.

FIG. 1 illustrates a method of ranking a global reputation GA of user A in a social network 100 with multiple communities in accordance with one novel aspect. Within social network 100, the reputation of a user represents different levels of recognition, attention, social status, and accomplishment of the user. The reputation of each user thus can be associated with different levels of needs within social network 100. As depicted by block 110, these needs can be categorized into, from low level to high level, physiological needs, safety needs, social needs, esteem needs and self actualization. When there are multiple communities, each user may have different individual reputation/ratings associated with different communities. In the example of FIG. 1, user A participates in two different communities 1 and 2. User A has a reputation value of 50 in community 1 and a reputation value of 80 in community 2. It is desirable to be able to determine an overall reputation for user A. Conceptually, even without quantitative calculation, based on user A's individual reputation values in community 1 and community 2, a global reputation value GA of user A can be determined and associated with one of the categories listed in block 110. In one novel aspect, in addition to the individual reputation values, the global reputation of a user is determined based on various considerations to more accurately reflect the overall reputation of the user in a social network with multiple communities.

FIG. 2 illustrates a first consideration for determining user's reputation based on user's level of participation. In general, for multiple communities, a user may have access to only a certain numbers of communities and may have no access to other communities. Even when a user has access to a specific community, the user may not participate in any social activity. These cases should be treated differently in determining user's reputation. The present invention proposes the following guidelines described by table 200 in FIG. 2:
When a user has no access to a community, there is no reputation of the user in that community. This situation should not impact the user's global reputation;
When a user has access to a community, but the user never posts any idea or comment. This inactivity would have negative impact on user's global reputation;
When a user has access to a community and also posts one or more ideas or comments. This activity would naturally have positive impact on user's global reputation.

FIG. 3 illustrates a second consideration for determining user's reputation based on quantity of participation and quality of participation. For each user, the volume of participation (e.g., submission) will vary. Based on the submission, the corresponding response (e.g., votes or comment responses) will also vary. In general, if two users had the same number of up and down votes and/or comment responses, but with significantly different quantities of submissions, then the effect of user reputation will be different. Table 300 in FIG. 3 lists four scenarios of how quality and quantity of user's activities may impact on user's reputation:
scenario 1—when a user has few submissions and gets few votes or comment responses, the impact on user's reputation varies, i.e. non-deterministic;
scenario 2—when a user has few submissions but gets many votes or comment responses, the impact on user's reputation is likely to be positive because the submission generates lot of interests and responses from the community;
scenario 3—when a user has many submissions and gets few votes or comment responses, the impact on his reputation is likely to be negative because the submission generates little interests and responses from the community;
scenario 4—when a user has many submissions and gets many votes or comment responses, the impact on his reputation varies, i.e. non-deterministic.

FIG. 4 illustrates a third consideration for determining a user's reputation based on content types submitted by the user. In general, some people will be prolific ideators, others will be good at thoughtful feedback, and both are valuable for the social network. Accordingly, the number of user votes is separated into votes on ideas and votes on comments because of the observed discrepancy of voting for idea versus voting for comments. Typically, ideas tend to receive much more votes than comments. In FIG. 4, the size of an oval represents the number of the votes received on an idea or a comment. From the diagram, the number of votes received on comments posted by a single user (e.g., 401) is usually less than the number of votes received on ideas posted by the user (e.g., 402). As a result, the total number of votes on all comments in the community (e.g., 403) normally is much less than the total number of votes on all ideas in the community (e.g., 404). A low vote count of comments should not skew the rating of a user. Therefore, when calculating user's rating, the number of votes received on comments should be treated separately from the number of votes received on ideas.

FIG. 5 illustrates a fourth consideration for determining user's global reputation on weighting coefficients of different communities. In a social network, multiple communities may be set up at different times and for different reasons. Different communities may be associated with different functionalities to face new challenges. Some communities thus will be more important than others in certain situations. With respect to user rating, weighting of votes in different communities is done to signify expertise of a person in one community rather than the other. For instance, a person may choose to be identified as an expert in a finance community because of his/her specific domain knowledge in finance, and choose to not let their opinion matter much other than the finance community. Thus user's ratings in difference communities should be weighted when calculating the global reputation. If users are not allowed to set the weights for each community, then the system admin or some other mechanism may be used to learn these weights based on user performance in respective communities.

Table 500 in FIG. 5 illustrates one example of such weighting mechanism. Under the default scenario, when calculating the global reputation for a user, the user's ratings in three communities, Community 1, Community 2 and Community 3, are evenly weighted by default, i.e. 33% each. However, in Scenario 1, a user's rating in Community 1 plays more weight (60%) than the ratings in Community B and Community C, with 30% and 10% weights respectively. This is because the user may have more expertise in Community 1's domain than in domains of Community 2 and Community 3. In Scenario 2, a user is equally proficient in the domains of Community 1 and Community 3, but does not have any domain knowledge applicable to Community 2. Therefore, the user's ratings in Community 1 and Community 3 are equally weighted to be 50% and the rating in Community 2 has no weighting at all (0%).

FIG. 6 illustrates a fifth consideration for determining user's global reputation based on volatility of the reputation. People's reputations will change over time as their participation and response varies. Extreme ends of reputation are most visible and judgmental, requiring sensitivity. As illustrated in FIG. 6, it is thus desirable to have reputation value fluctuate from 25%-75% (normal volatility) easily but not very fluidly from 25% to 0% and from 75% to 100% (slowed volatility). If a user's reputation is allowed to decrease up to 0% easily, then it is believed not be a good user experience. Likewise, if a user's reputation increases to 100% easily, then it is believed that it will not be good for the social network since many users might increase their reputations easily by collusion. As a result, the reputation of a user should be “smoothed” at extreme ends, 0% and 100%.

Based on above mentioned considerations, the present invention proposes a method for calculating the global reputation of a user participating in activities in multiple communities.

FIG. 7 illustrates a formula of calculating a global reputation G_{A} for user A from a plurality of community statistics. In general, the rating of user A in each community is first determined, and then the global reputation of user A is calculated based on the individual ratings in each community.

$${G}_{A} = \frac{{a}_{1} ( \frac{\frac{{u}_{{C}_{1}}^{i}}{{t}_{{C}_{1}}^{i}} + \frac{{u}_{{C}_{1}}^{c}}{{t}_{{C}_{1}}^{c}}}{{T}_{{C}_{1}}} ) + {a}_{2} ( \frac{\frac{{u}_{{C}_{2}}^{i}}{{t}_{{C}_{2}}^{i}} + \frac{{u}_{{C}_{2}}^{c}}{{t}_{{C}_{2}}^{c}}}{{T}_{{C}_{2}}} ) + … + {a}_{n} ( \frac{\frac{{u}_{{C}_{n}}^{i}}{{t}_{{C}_{n}}^{i}} + \frac{{u}_{{C}_{n}}^{c}}{{t}_{{C}_{n}}^{c}}}{{T}_{{C}_{n}}} )}{n}$$

$$or$$

$${G}_{A} = ℱ ( \frac{{\sum }_{j = 1}^{n} {a}_{j} ( \frac{\frac{{u}_{{C}_{j}}^{i}}{{t}_{{C}_{j}}^{i}} + \frac{{u}_{{C}_{j}}^{c}}{{t}_{{C}_{j}}^{c}}}{{T}_{{C}_{j}}} )}{n} )$$

where
G_{A}=global reputation of user A
n=number of communities that user A is a member of
u_{C}_{ⱼ}ⁱ=average number of up votes user A received per idea in community Cⱼ
t_{C}_{ⱼ}ⁱ=average number of up votes received per idea in community Cⱼ

$$\frac{{u}_{{C}_{j}}^{i}}{{t}_{{C}_{j}}^{i}} =$$

rating of user A on ideas submitted to community Cⱼ
u_{C}_{ⱼ}^{c}=average number of up votes user A received per comment in community Cⱼ
t_{C}_{ⱼ}^{c}=average number of up votes received per comment in community Cⱼ

$$\frac{{u}_{{C}_{j}}^{c}}{{t}_{{C}_{j}}^{c}} =$$

rating of user A on comments submitted to community Cⱼ
T_{C}_{ⱼ}=average number of votes (up and down) received per submission (ideas and comments) in community Cⱼ
aⱼ=weighting coefficient for each community such that:

$${\sum }_{j = 1}^{n} {a}_{j} = 1$$

[symbol] =function which controls the fluidity of global reputation

To incorporate the consideration illustrated in FIG. 2, only communities that user A is a member (e.g., user A has access) are included, with a total number of communities equal to n. To incorporate the consideration illustrated in FIG. 3, a user's quality and quantity of participation should be reflected. Since u_{C}_{ⱼ}ⁱ is the average number of up votes user A received per idea in community Cⱼand u_{C}_{ⱼ}^{c} is the average number of up votes user A received per comment in community Cⱼ, both u_{C}_{ⱼ}ⁱ and u_{C}_{ⱼ}^{c} have positive impact on the reputation. Furthermore, a user's quality and quantity of participation should be measured against other users in the community. Therefore, t_{C}_{ⱼ}ⁱ representing the average number of up votes received per idea in community Cⱼ and t_{C}_{ⱼ}^{c} representing the average number of up votes received per comment in community Cⱼ are included in the formula.

To meet the consideration illustrated in FIG. 4, both prolific ideators and good commenters are treated fairly. Thus, the up votes a user received for ideas and comments are calculated independently against average of other users. To meet the consideration illustrated in FIG. 5, a weight coefficient is introduced for each community, i.e. aⱼ for community j.

Finally, to address the design consideration illustrated in FIG. 6, a smooth function F is used to reduce the volatility at both extreme low end and high end. Global reputation is envisioned to be fluid between the value of 25% to 75% and not fluid from the intervals 0-25% and 75%-100%. Therefore, applying a curve smoothing function can regulate the fluidity of reputation values. Let function [symbol] be this control function.

$$ℱ ( x ) = 1 - {e}^{- {( \frac{x}{scale * max ( x )} )}^{shape}}$$

where
x represents global reputation
scale is used to center the midpoint of the curve on the x axis
max is the maximum value reputation can take
shape is the sharpness of the curve.

FIG. 8 illustrates an example of a curve smoothing function that can be applied for calculating global reputation values. In table 810 at the top of FIG. 8, the “rep” column represents the original global reputation value. There are three parameters, scale, max and shape to control the smoothness of the final curve. The function column lists the final global reputation value after applying the smooth function. In this example, scale=0.5, max(x)=1, and shape=3. In curve graph 820 at the bottom of FIG. 8, the x-axis represents the original global reputation value as input of the smooth function F and the y-axis represents the final global reputation as output from the smooth function F(x). From both table 810 and curve graph 820, it is evident that the global reputation value changes much slower at both extreme ends, near 0 and 1.

FIGS. 9-13 illustrate one example of calculating a global reputation value of users across multiple communities. A total of four communities are used. The user submissions and feedbacks/votes statistics in the four communities are used to calculate the global reputation of user A and user B.

FIG. 9 illustrates the community statistics for all users and all submissions/votes. The votes are then averaged out over all communities for normalization. In order to simplify the calculation, it is assumed that all four communities have the same community level statistics. In each community, there are total 60 users who submitted total 42 ideas and 86 comments. For 42 ideas, 64 up votes and 26 down votes are received. For 86 comments, total 32 up votes and 18 down votes are received. As a result, there are total 128 submissions and 140 total votes received.

To calculate average up votes per idea, the total number of up votes on ideas (64) is divided by the total number of ideas (42) and the result is 1.52. That is:

t_{C}_{ⱼ}ⁱ=1.52 (j=1,2,3,4)

Similarly, the average up votes on comments is calculated by dividing the total number of up votes on comments (32) by the total number of comments (86) and the result is 0.37. That is:

t_{C}_{ⱼ}^{c}=0.37 (j=1,2,3,4)

If the total number of votes (140) is divided by total number of submission (128), the average number of votes per submission is obtained as 1.09. That is:

T_{C}_{ⱼ}=1.09 (j=1,2,3,4)

FIG. 10 illustrates community statistics for user A and the corresponding community reputation values for each community. User A has submitted 21 ideas in community 1 and received 20 up votes. Thus,

u_{C}_{₁}ⁱ=20/21=0.952380952

User A has submitted 21 ideas in community 2 and received 5 up votes. Thus,

u_{C}_{₂}ⁱ=5/21=0.238095238

User A has submitted 8 ideas in community 3 and received 20 up votes. Thus,

u_{C}_{₃}ⁱ==20/8=2.5

User A has submitted 8 ideas in community 4 and received 5 up votes. Thus,

u_{C}_{₄}ⁱ==5/8=0.625

User A submitted 43 comments in community 1 and received 4 up votes. Thus

u_{C}_{₁}^{c}=4/43=0.093023256

User A submitted 43 comments in community 2 and received 1 up vote. Thus

u_{C}_{₂}ⁱ=1/43=0.023255814

User A submitted 17 comments in community 3 and received 4 up votes. Thus

u_{C}_{₃}ⁱ==1/17=0.058823529

User A submitted 17 comments in community 4 and received 1 up votes. Thus

u_{C}_{₄}⁹==1/17=0.058823529

Equal weight (0.25) is applied on all four communities. That is, aⱼ=0.25 (j=1,2,3,4). Accordingly, user A's global reputation among four communities can be determined as following:

$$\begin{matrix}{G}_{A} = \frac{\begin{matrix}{a}_{1} ( \frac{\frac{{u}_{{C}_{1}}^{i}}{{t}_{{C}_{1}}^{i}} + \frac{{u}_{{C}_{1}}^{c}}{{t}_{{C}_{1}}^{c}}}{{T}_{{C}_{1}}} ) + {a}_{2} ( \frac{\frac{{u}_{{C}_{2}}^{i}}{{t}_{{C}_{2}}^{i}} + \frac{{u}_{{C}_{2}}^{c}}{{t}_{{C}_{2}}^{c}}}{{T}_{{C}_{2}}} ) + \\ {a}_{3} ( \frac{\frac{{u}_{{C}_{3}}^{i}}{{t}_{{C}_{3}}^{i}} + \frac{{u}_{{C}_{3}}^{c}}{{t}_{{C}_{3}}^{c}}}{{T}_{{C}_{3}}} ) + {a}_{4} ( \frac{\frac{{u}_{{C}_{4}}^{i}}{{t}_{{C}_{4}}^{i}} + \frac{{u}_{{C}_{4}}^{c}}{{t}_{{C}_{4}}^{c}}}{{T}_{{C}_{4}}} )\end{matrix}}{4} \\ = ( \begin{matrix}0.213392857 + 0.053348214 + \\ 0.554694065 + 0.138673516\end{matrix} ) / 4 \\ = 0.230027163\end{matrix}$$

FIG. 11 illustrates community statistics for user B and the corresponding community reputation values for each community. As shown in the table in FIG. 11, user B has submitted 21 ideas in community 1, 21 ideas in community 2, 8 ideas in community 3, and 8 ideas in community 4. User B also submitted 43 comments in community 1, 43 comments in community 2, 17 comments in community 3, and 17 comments in community 4. The numbers of up votes user B received for the submitted ideas are 5, 5, 5 and 5 from communities 1, 2, 3 and 4 respectively. The numbers of up votes user B received for the submitted comments are 1, 1, 1 and 1 from communities 1, 2, 3 and 4 respectively. Equal weight (0.25) is applied on all four communities. That is, aⱼ=0.25 (j=1,2,3,4). Based on same calculation as for user A, user B's global reputation among four communities can be determined as following:

$${u}_{{C}_{1}}^{i} = 5 / 21 = 0.238095238$$

$${u}_{{C}_{2}}^{i} = 5 / 21 = 0.238095238$$

$${u}_{{C}_{3}}^{i} == 5 / 8 = 0.625$$

$${u}_{{C}_{4}}^{i} == 5 / 8 = 0.625$$

$${u}_{{C}_{1}}^{c} = 1 / 43 = 0.023255814$$

$${u}_{{C}_{2}}^{i} = 1 / 43 = 0.023255814$$

$${u}_{{C}_{3}}^{i} = 1 / 17 = 0.058823529$$

$${u}_{{C}_{4}}^{i} == 1 / 17 = 0.058823529$$

$$\begin{matrix}{G}_{A} = \frac{\begin{matrix}{a}_{1} ( \frac{\frac{{u}_{{C}_{1}}^{i}}{{t}_{{C}_{1}}^{i}} + \frac{{u}_{{C}_{1}}^{c}}{{t}_{{C}_{1}}^{c}}}{{T}_{{C}_{1}}} ) + {a}_{2} ( \frac{\frac{{u}_{{C}_{2}}^{i}}{{t}_{{C}_{2}}^{i}} + \frac{{u}_{{C}_{2}}^{c}}{{t}_{{C}_{2}}^{c}}}{{T}_{{C}_{2}}} ) + \\ {a}_{3} ( \frac{\frac{{u}_{{C}_{3}}^{i}}{{t}_{{C}_{3}}^{i}} + \frac{{u}_{{C}_{3}}^{c}}{{t}_{{C}_{3}}^{c}}}{{T}_{{C}_{3}}} ) + {a}_{4} ( \frac{\frac{{u}_{{C}_{4}}^{i}}{{t}_{{C}_{4}}^{i}} + \frac{{u}_{{C}_{4}}^{c}}{{t}_{{C}_{4}}^{c}}}{{T}_{{C}_{4}}} )\end{matrix}}{4} \\ = ( \begin{matrix}0.053348214 + 0.053348214 + \\ 0.138673516 + 0.138673516\end{matrix} ) / 4 \\ = 0.096010865\end{matrix}$$

FIG. 12 illustrates an example of high/low positive feedback (F) and high/low submission (S). High submission is defined as user submits more than 50% of the ideas and 50% of the comments while low submissions means user submits less than 5% of the ideas and 5% of the comments. If more than 80% of the votes a user receives are positive (up) it is considered as high positive feedback, and if less than 20% of the votes a user receives are positive (up) it is considered as low positive feedback. Based on user A's statistics in FIG. 10, one can see that user A has high submissions with high positive feedback in community 1, high submissions with low positive feedback in community 2, low submissions with high positive feedback in community 3 and low submissions with low positive feedback in community 4. Similarly, based on user B's statistics in FIG. 11, one can see that user B has high submissions with low positive feedback in community 1 and 2 and low submissions with low positive feedback in community 3 and 4.

To incorporate the design consideration shown in FIG. 6, FIG. 13 illustrates the global reputation values of user A and user B, and the final global reputation values of user A and user B after applying a curve smoothing function to regulate the fluidity of reputation values. For this example, the parameters are set as scale=0.5, max(x)=1 and shape=3. As a result, for user A, final global reputation is [symbol] (GA)=0.104729664 and for user B, the final global reputation is [symbol] (GB)=0.007055285.

Reference will now be made in detail to embodiments of the invention for the system implementation of global reputation computation.

FIG. 14 illustrates computer-based system 1400 according to the present invention for computing value of crowd. System 1400 comprises a server computer 1401, a Local area network (LAN) or wide area network (WAN) or Internet 1402, a plurality of network connections 1403, and a plurality of data source servers 1404-1407. The server computer 1401 furnishes user with input and output interfaces and performs global reputation computation. Data source servers 1404, 1405, 1406, and 1407 provide network interfaces for server 1401 to retrieve data of user activities in a social network. Network 1402 provides connectivity via wired or wireless network connections 1403 between server computer 1401 and data source servers 1404-1407. In the example of FIG. 14, data source servers are various web sites provide social networking, such as Facebook 1404 and Google Plus 1405, or online content sharing such as Flickr 1406 or other social network 1407. User activities (posts, comments, and votes) of registered users are stored on the data source servers. By retrieving user activity data, server 1401 can calculate the global reputation values for users.

FIG. 15 is a simplified block diagram of a server computer 1500 that calculates the global reputation of a registered user in a social network. Server computer 1500 comprises a processor 1501, a user interface and peripherals 1502 such as monitor, keyboard and mouse, a network input and output (I/O) module 1503 for sending and receiving data, and a storage device 1504 for storing data. The storage device 1504 is a type of computer-readable medium (i.e. a type of memory such as RAM, ROM, CD, DISK, etc.), and further comprises software programs 1505 and a database 1506 that implement the computing of the global reputation of a user. Software programs 1505 comprise program instructions stored in the computer-readable medium, when executed by processor 1501, causing the processor and other software and/or hardware modules to perform desired functions.

FIG. 15 also shows the main functional modules on server 1401 in FIG. 14. The functional modules include an input module 1521, an output module 1526, a data collection module 1522, an activity statistics generation module 1523, a community reputation module 1524, and a global reputation calculation module 1525. Input module 1521 retrieves data from external servers or users. Data collection module 1522 pre-processes the input data related to the user activities in social networks and the reformatted input data is stored in a server database 1506. Activity statistics generation module 1523 constructs the input data from database 1506 to generate statistics for user activities in each community. For activities of each user in a community, statistics include total number of submitted ideas, comments, and up and down votes received for the submitted ideas and comments. In addition, for each community, the generated statistics include total number of submitted ideas, comments, and up and down votes received for the ideas and comments. User reputation in each community is first calculated by community reputation module 1524 based on these statistics, and global reputation calculation module 1525 calculates the global reputation for users based on the user reputation in each community. Finally, output module 1526 outputs the results from module 1525.

FIG. 16 is a flow chart for processing input data of user activities from data source servers and calculating the global reputation for users. The input data about user activities in social networks are collected at block 1601. The input data include statistics on user's submitted ideas and comments as well as the votes from other user regarding the submitted ideas and comments. From the input data, first the community level statistics are generated at block 1602. Statistics at community level include t_{C}_{ⱼ}ⁱ, average number of up votes received per idea in community Cⱼ, t_{C}_{ⱼ}^{c}, average number of up votes received per comment in community Cⱼ and T_{C}_{ⱼ}, average number of votes (up and down) received per submission (ideas and comments) in community Cⱼ. These statistics are generated for all communities. At block 1603, user statistics are generated for each user. User statistics include u_{C}_{ⱼ}ⁱ, average number of up votes the user received per idea in community Cⱼ, u_{C}_{ⱼ}^{c}, average number of up votes user A received per comment in community Cⱼ and aⱼ, weighting coefficient for each community such total number of submitted ideas. Note that for each user, statistics need to be generated for all communities. Then at block 1604, user's global reputation is calculated based on the formula. Finally, final global reputation values for all users are output to the user interface. The output can be in graphical display or matrix format.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
generating a first activity stats of a user associated with a first community, wherein the first activity stats indicates a rating on ideas submitted to the first community by the user and a rating on comments submitted to the first community by the user;
generating a second activity stats of the user associated with a second community, wherein the second activity stats indicates a rating on ideas submitted to the second community by the user and a rating on comments submitted to the second community by the user;
calculating a first reputation value for the user in the first community and a second reputation value for the user in the second community; and
calculating a global reputation value for the user based on the first reputation value and the second reputation value.

2. The method of claim 1, wherein user activities for collected activity stats comprise submitting ideas, submitting comments, and providing/receiving up votes or down votes for the submitted ideas/comments.

3. The method of claim 1, wherein the rating on ideas submitted to the first community by the user is based on an average number of up votes received per idea for the user divided by an average number of up votes received per idea for all users of the first community.

4. The method of claim 1, wherein the rating on comments submitted to the first community by the user is based on an average number of up votes received per comment for the user divided by an average number of up votes received per comment for all users of the first community.

5. The method of claim 1, wherein the first reputation value is based on the rating on ideas plus the rating on comments submitted to the first community by the user divided by an average number of votes received per submission for all users in the first community.

6. The method of claim 1, wherein the first reputation value and the second reputation value are applied with corresponding weighting coefficients of each community for calculating the global reputation value.

7. The method of claim 6, wherein a weighting coefficient of the first community is related to specific knowledge of the user about the first community.

8. The method of claim 6, wherein a weighting coefficient of the first community is related to user performance in the first community.

9. The method of claim 1, wherein the global reputation value is applied with a curve smooth function to regulate fluidity of the global reputation value.

10. A system for computing global reputation for a user, the system comprises:
an activity stats module that generates a first activity stats of the user associated with a first community, wherein the first activity stats indicates a rating on ideas submitted to the first community by the user and a rating on comments submitted to the first community by the user, wherein the activity stats module also generates a second activity stats of the user associated with a second community, wherein the second activity stats indicates a rating on ideas submitted to the second community by the user and a rating on comments submitted to the second community by the user;
a community reputation module that calculates a first reputation value for the user in the first community and a second reputation value for the user in the second community; and
a global reputation calculation module that calculates a global reputation value for the user based on the first reputation value and the second reputation value.

11. The system of claim 10, wherein user activities for collected activity stats comprise submitting ideas, submitting comments, and providing/receiving up votes or down votes for the submitted ideas/comments.

12. The system of claim 10, wherein the rating on ideas submitted to the first community by the user is based on an average number of up votes received per idea for the user divided by an average number of up votes received per idea for all users of the first community.

13. The system of claim 10, wherein the rating on comments submitted to the first community by the user is based on an average number of up votes received per comment for the user divided by an average number of up votes received per comment for all users of the first community.

14. The system of claim 10, wherein the first reputation value is based on the rating on ideas plus the rating on comments submitted to the first community by the user divided by an average number of votes received per submission for all users in the first community.

15. The system of claim 10, wherein the global reputation is calculated by aggregating community reputation values with a corresponding weighting coefficient for each community.

16. The system of claim 15, wherein the weighting coefficients for each community are set by a system administrator.

17. The system of claim 15, wherein the weighting coefficients for each community are determined based on user performance in corresponding communities.

18. The system of claim 10, wherein the global reputation value is obtained by applying a smooth function to regulate the fluidity of the global reputation value.
